(19) United States
(12) Patent Application Publication
(10) Pub. No.: US 2010/0077537 A1
(43) Pub. Date: Apr. 1, 2010

(54) Multicolor frameless diving masks and method for making the same

(76) Inventor: Hsiang-Chou Lan, Hsi Chih City (TW)

Correspondence Address: BIRCH STEWART KOLASCH & BIRCH, PO BOX 747, FALLS CHURCH, VA, 22040-0747, US

(21) Appl. No.: 12/285,159

(22) Filed: Sep. 30, 2008

(51) Int. Cl. A63B 33/00; B63C 11/12; B29C 45/14; B29C 45/16

(52) U.S. Cl. 2/428; 351/43; 264/245; 264/279

(57) ABSTRACT

Disclosed are a pair of multicolor frameless diving masks and a method for making the same. The method mainly includes injection molding a skirt of a cover body of the diving masks in a first mold; applying an adhesive to an edge of the skirt and an edge of a lens; and placing the skirt and the lens in a second mold and injection molding the remaining portion of the cover body. Thus, the cover body of the diving masks is integrally formed in the second mold to produce a leakproof diving masks having different hues.

### BACKGROUND OF THE INVENTION

1. Technical Field

The present invention relates to diving masks, and more particularly, to a pair of multicolor frameless diving masks and a method for making the same, in which the pair of multicolor diving masks is made by using different molds.

2. Description of Related Art

The structure of diving masks is well known and well established, leaving little room for improvement in its shape due to the fact that such masks, to be worn on users' faces, must conform to human facial contours. However, the existing mask structures can be improved upon to provide a more comfortable wearing experience. In early days, diving masks are made by first preparing a plurality of components and then manually putting the components together. Since leakproofness of masks thus made depends on whether or not the components are tightly assembled with each other, tiny interstices between the various components may lead to leaking problems under high water pressure.

Another conventional and yet more recently developed structure of a pair of diving masks is shown in FIG. 1, wherein a cover body 10 has a front side made of a tough material to form an outer cover 11, and an inner periphery intended to contact a wearer's face and made of a soft material to form a skirt 12, which is capable of conforming to the wearer's facial contour and thus allows the masks to be comfortably worn. A lens 31 is then fitted into the outer cover 11, before the outer cover 11 and the lens 31 are forcibly fitted into a plastic outer frame 30. The structure of the diving masks is completed by attaching a strap 20 to a backside of the cover body 10, so that the masks can be worn with the soft skirt 12 in contact with the user's skin while providing improved leakproofness and comfortableness. However, this kind of structure requires a complicated manufacturing process, as explained below.

Referring to FIG. 2 in conjunction with FIG. 1, the manufacturing process of the aforementioned structure of a pair of diving masks generally includes the following steps:

(1) providing a precision mold at a step 40, wherein the mold has divided spaces to facilitate injection of different molding materials;

(2) injecting two materials having different levels of hardness at a step 41, wherein the materials are injected separately into the precision mold so as to be formed;

(3) producing a cover body of the two materials at a step 42, wherein the cover body of the two materials (different levels of hardness) is released from the mold; and

(4) assembling the cover body with a lens and a plastic outer frame at a step 43, so as to produce a final product of the diving masks.

However, the manufacturing process described above has the following drawbacks. First of all, during the manufacturing process of the diving masks, the molding materials are injected into the same mold. Consequently, the mold must have high precision and, as a result, a high cost. Further, during injection, if the different materials have a great temperature difference, the necessary cooling time will be increased, thereby lengthening the manufacturing process and slowing down production speed. In addition, installation of the plastic outer frame after the lens is fitted into a rim of the masks only increases the difficulty in production without eradicating the leaking problem.

Moreover, the use of two different materials demands not only complicated logistic management but also modification of equipment, which also adds to the cost of the prior art diving masks.

### BRIEF SUMMARY OF THE INVENTION

A primary objective of the present invention is to provide a pair of integrally formed, multicolor diving masks characterized by being made with a plurality of molds, wherein a silica gel of different colors is molded separately in the different molds in combination with a lens.

### BRIEF DESCRIPTION OF THE SEVERAL VIEWS OF THE DRAWINGS

The invention as well as a preferred mode of use, further objectives and advantages thereof will be best understood by referring to the following detailed description of an illustrative embodiment in conjunction with the accompanying drawings, wherein:

FIG. 1 is an exploded view of a conventional diving mask;

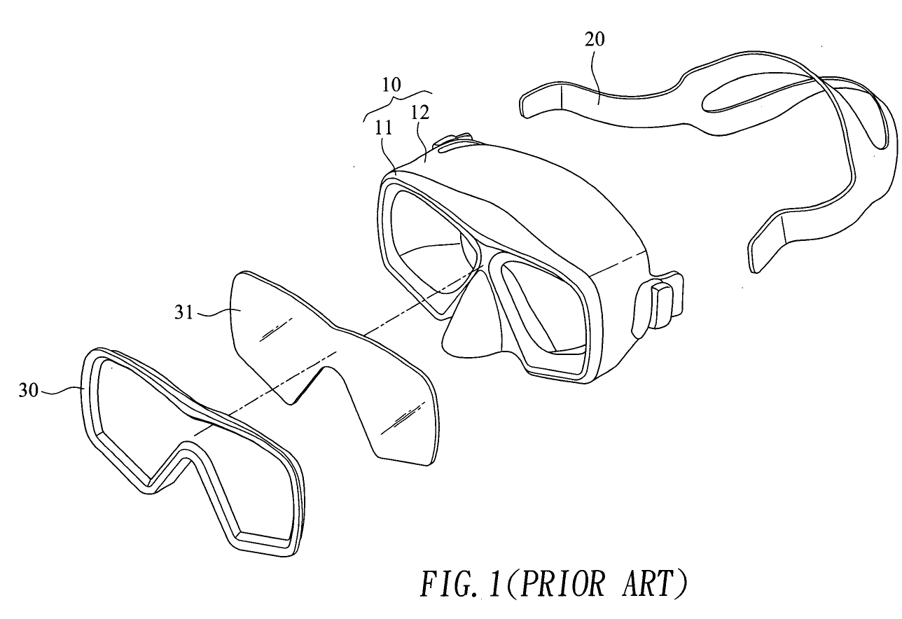

FIG. 2 is a flowchart of a method for making the conventional diving mask;

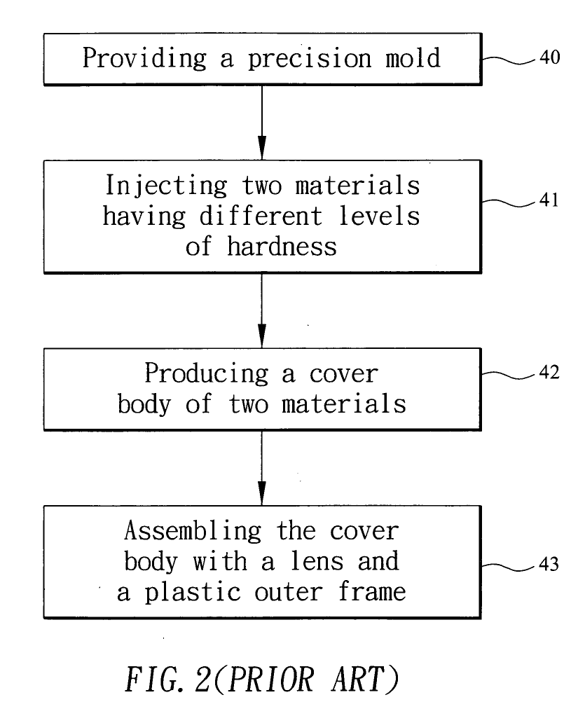

FIG. 3 is a perspective view of a pair of diving masks according to the present invention; and

FIG. 4 is a flowchart of a method for making the diving masks according to the present invention.

### DETAILED DESCRIPTION OF THE INVENTION

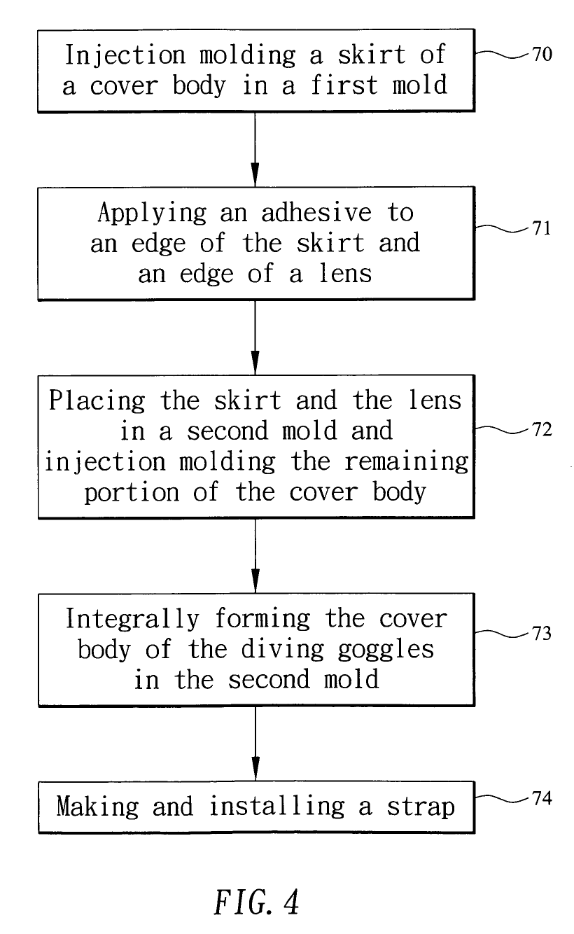

Referring to FIG. 4, a method for making a pair of diving masks according to the present invention includes the following steps.

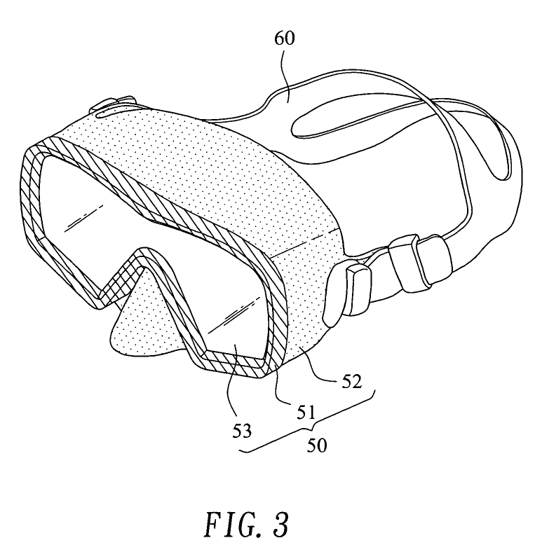

(1) At a step 70, a skirt 52 of a cover body 50 is injection molded in a fist mold, wherein the skirt 52, as shown in FIG. 3, is made of a silica gel having an appropriate color to produce a quality appearance in a distinctive hue.

(2) At a step 71, an adhesive is applied to an edge of the skirt 52 and an edge of a lens 53. Referring to FIG. 3, the skirt 52 and the lens 53 are partially coated with the adhesive because they have to be tightly assembled with the remaining portion of the cover body 50 to prevent water from passing through joints therebetween.

(3) At a step 72, the skirt 52 and the lens 53 are placed in a second mold so as to injection mold the remaining portion of the cover body 50, wherein the remaining portion mainly includes an outer cover 51, as shown in FIG. 3. The injection molding material used in the second mold is the same as that used to injection mold the skirt 52, except that the former has a different color from the latter. The different colors may be selected so as to match each other, thereby enabling various combinations of similar hues. The lens 53, which is typically made of glass, is placed in the second mold so as to be set in lens-receiving holes of the outer cover 51 and the skirt 52, respectively.

(4) At a step 73, the cover body 50 of the diving masks is integrally formed in the second mold, wherein the skirt 52 previously made from the first mold is further coated in the second mold. By virtue of the adhesive and a bonding effect of the molding material during the forming process, the diving masks thus made shall have a sturdy structure.

(5) At a step 74, a strap 60 is made and installed, wherein the strap 60, as shown in FIG. 3, is separately prepared and has two ends thereof respectively connected to two sides of the cover body 50 to complete the diving masks.

Thus, as shown in FIG. 3, the cover body 50 of the diving masks according to the present invention is made by first using the first mold to form the skirt 52, and then using the second mold to form the remaining portion of the cover body 50, such as the outer cover 51, and have the lens 53 set in place. After installing the strap 60, a multicolor diving masks having a high quality look is finally obtained.

An advantage of the present invention is an improved overall appearance with enhanced color design, plus a clean and securely set lens. This is achieved by the use of two molds and a two-stage injection molding process, which allows the diving masks to be made of a silica gel of different colors.

Another advantage of the present invention is that the pair of diving masks is integrally formed, so that the plastic outer frame required in the prior art can be dispensed with, thereby effectively solving the leaking problem of conventional diving masks.

The present invention is developed from an innovative concept and, according to experiments conducted by the inventor, is capable of delivering the intended effects. As the present invention meets the requirements of industrial applicability, novelty and utility for patent application, an application for patent of the present invention is hereby lawfully filed for examination.

1. A method for making a pair of multicolor frameless diving masks, comprising steps of:
(1) injection molding a skirt of a cover body of the diving masks in a first mold;
(2) applying an adhesive to an edge of the skirt and an edge of a lens;
(3) placing the skirt and the lens in a second mold and injection molding a remaining portion of the cover body; and
(4) integrally forming the cover body of the diving masks in the second mold so as to obtain the diving masks.

2. The method for making a multicolor frameless diving masks as claimed in claim 1, wherein the skirt injection molded from the first mold and the remaining portion of the cover body injection molded from the second mold have colors in similar hues.

3. The method for making a multicolor frameless diving masks as claimed in claim 1, wherein the skirt injection molded from the first mold and the remaining portion of the cover body injection molded from the second mold have different colors.

4. The method for making a multicolor frameless diving masks as claimed in claim 1, wherein the lens is made of glass.

5. The method for making a multicolor frameless diving masks as claimed in claim 1, wherein the step (4) further comprises attaching a strap to two sides of the diving masks released from the second mold.

6. A pair of multicolor frameless diving masks, comprising:
a cover body comprising a skirt and an outer cover, wherein the skirt is made from a first mold while a second mold is used to make the outer cover and have a lens set in place; and
a strap having two ends attached to two sides of the cover body.

7. The multicolor frameless diving masks as claimed in claim 6, wherein the skirt and the outer cover have different colors.

8. The multicolor frameless diving masks as claimed in claim 6, wherein the color of the skirt and the color of the outer cover are in similar hues.

9. The multicolor frameless diving masks as claimed in claim 6, wherein the skirt, the outer cover and the lens are integrally formed.
